(19) United States
(12) Patent Application Publication
(10) Pub. No.: US 2006/0017285 A1
(43) Pub. Date: Jan. 26, 2006

(54) Flexible tube for an exhaust pipe of an automobile

(76) Inventor: Dae Hyun Kim, Ansan-si (KR)

Correspondence Address: MADSON & METCALF;GATEWAY TOWER WEST, SUITE 900, 15 WEST SOUTH TEMPLE, SALT LAKE CITY, UT, 84101, US

(21) Appl. No.: 10/929,849

(22) Filed: Aug. 30, 2004

(30) Foreign Application Priority Data
Jul. 20, 2004 (KR) 2004-0056469

(51) Int. Cl. F16L 27/12

(52) U.S. Cl. 285/300

(57) ABSTRACT

A flexible tube for an exhaust pipe of an automobile, which has a spring member provided along a circumferential surface of outer braids thereof, so that the vibration of the flexible tube and the generation of noise and harshness caused by over-vibration of an exhaust system can be suppressed and riding comfort of drivers and passengers can be improved. The flexible tube according to the present invention comprises a bellows member (10) corrugated to have alternate ridges (11) and furrows (12) along its outer periphery; outer braids (30) provided at a predetermined distance from the outer periphery of the bellows member (10); fixing caps (40) fitted onto both side ends of the outer braids (30) respectively; and a spring member (60) provided on a circumferential surface of the outer braids (30) to be closely contacted thereto.

### FIELD OF THE INVENTION

The present invention relates to a flexible tube for an exhaust pipe of an automobile, and more particularly to a flexible tube having a spring member provided along a circumferential surface of outer braids thereof, so that the vibration of the flexible tube and the generation of noise and harshness caused by over-vibration of an exhaust system can be suppressed and riding comfort of drivers and passengers can be improved.

### BACKGROUND OF THE INVENTION

These days, automobiles tend to have an increased vibration of engine roll in case of engine starting, abrupt starting and braking of an automobile or gear shifting, due to increased output of power from the engine.

Further, depending on various conditions of roads, the vibration of an exhaust pipe is generated while driving.

Therefore, an engine of an automobile is connected to the exhaust pipe so that the exhaust gas can be discharged, and in an intermediate part between the engine and the exhaust pipe, a flexible tube is provided as a decoupler joint, which is firm and compact enough to absorb and buffer displacements of vibration, load of impact, heat distortion, etc.

As shown in FIG. 1 and disclosed in EP 0410089 A1, a conventional flexible tube includes a bellows member (10) of metallic material in the form of a corrugated cylinder to absorb stresses due to extension, contraction or bending thereof, and an interlock member (20) provided in the bellows member (10) to absorb stresses due to extension, contraction, bending, etc. and controlled to be displaced within the limit of elasticity of the bellows member (10), so that the exhaust gas can flow therethrough smoothly and the bellows member (10) can be protected from the exhaust gas in high temperatures.

The conventional flexible tube further includes outer braids (30) enclosing the external surface of the bellows member (10).

With the outer braids (30) surrounding the bellows member (10), both ends of the outer braids (30) are circumferentially compressed with fixing caps (40) and they are together spot-welded for secure attachment.

With the above structure, the conventional flexible tube is connected to the engine at one end and to the exhaust pipe at the other end, thus facilitating the smooth passage of the exhaust gas therethrough and absorbing the impact and stresses generated between the engine and the exhaust pipe through the extension and contraction of the bellows member (10) and the interlock member (20).

The conventional flexible tube, however, has been designed to be long in its total length to improve the riding comfort of drivers and passengers of the automobile, and accordingly the bellows member (10) was corrugated long enough to have many ridges and furrows.

Accordingly, when over-vibration occurred in the exhaust system, the vibration on the flexible tube increased, in which case the outer braids (30) enclosing the bellows member (10) came into contact with the bellows member (10) intermittently and such contact caused abrasion and noise. Thus, N.V.H. (noise, vibration & harshness) evaluation deteriorated and the endurance of the flexible tube became reduced.

### SUMMARY OF THE INVENTION

The object of the present invention is to provide a flexible tube for an exhaust pipe of an automobile, which includes a spring member along a circumferential surface of outer braids thereof, so that the vibration of the flexible tube and the generation of noise and harshness caused by over-vibration of an exhaust system can be suppressed and the N.V.H. evaluation of the automobile and the endurance of the flexible tube can be improved.

In order to achieve the above object, the flexible tube for an exhaust pipe of an automobile according to the present invention comprises:

a bellows member formed in a shape of a hollow cylinder having a predetermined width and length and corrugated to have alternate ridges and furrows along its outer periphery;

outer braids woven at predetermined angles and provided at a predetermined distance from the outer periphery of the bellows member to enclose the bellows member;

fixing caps fitted onto both side ends of the outer braids respectively, so that both side ends of the outer braids can be fixed around both side ends of the bellows member; and

a spring member having elasticity and provided on a circumferential surface of the outer braids to be closely contacted thereto.

Since the spring member is provided along the circumferential surface of the outer braids in such a manner to surround and elastically clamp the surface, if over-vibration is generated in the exhaust system, the elastic force of the spring member can promote damping of the outer braids and the bellows member.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention, wherein:

FIG. 1 is a partial sectional view of the conventional flexible tube for an exhaust pipe of an automobile;

FIG. 2 is a partial sectional view of a flexible tube for an exhaust pipe of an automobile according to an embodiment of the present invention;

FIG. 3 is a partial enlarged view of FIG. 2;

FIG. 4 is a partial sectional view showing a flexible tube for an exhaust pipe of an automobile according to another embodiment of the present invention; and

FIG. 5 is a partial enlarged view of FIG. 4.

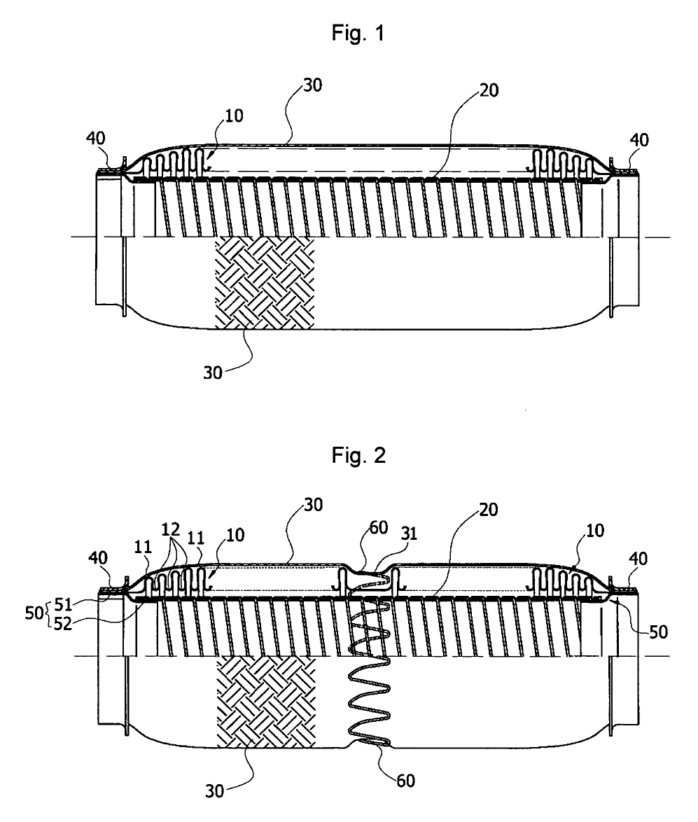

### DESCRIPTION OF THE PREFERRED EMBODIMENTS

Reference will now be made in detail to preferred embodiments of the present invention in conjunction with the accompanying drawings.

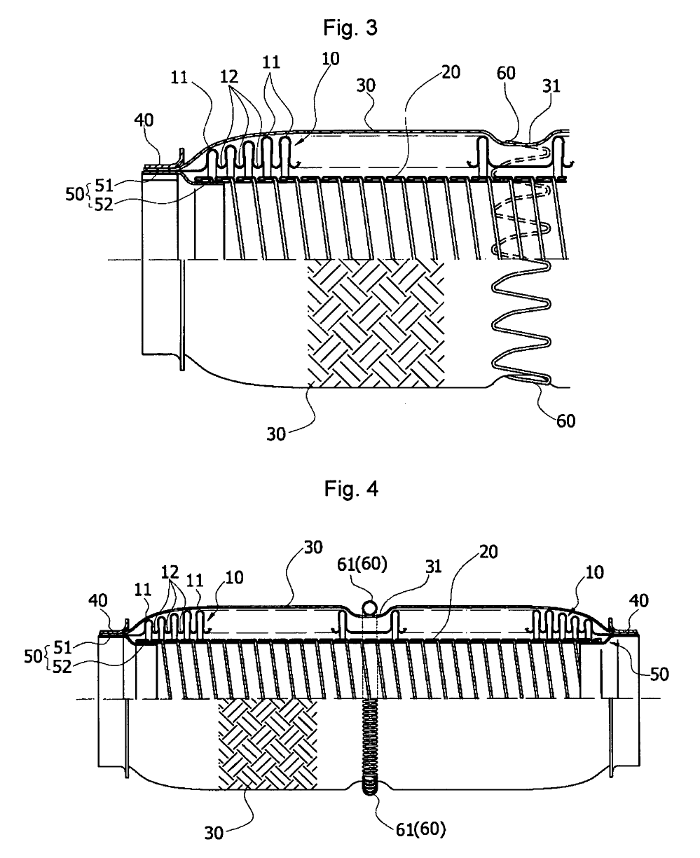

FIG. 2 shows the basic structure of a flexible tube for an exhaust pipe of an automobile according to the present invention and FIG. 3 shows a partially enlarged view of FIG. 2, wherein a groove (31) for mounting a spring member (60) thereon is formed along the central circumferential surface of outer braids (30) and the spring member (60) is seated on the groove (31) to closely contact the central circumferential surface of the outer braids (30).

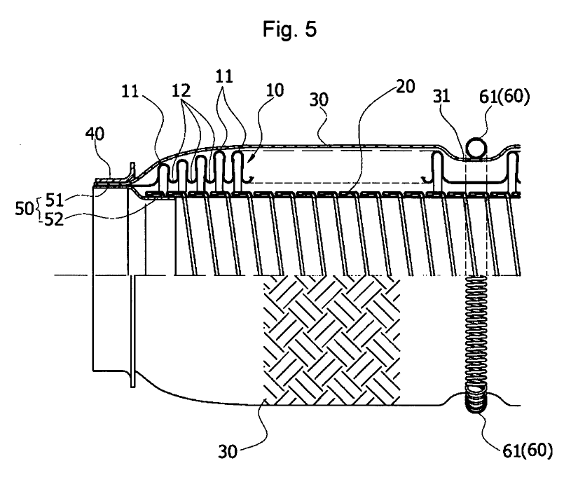

FIG. 4 shows another embodiment of the flexible tube for an exhaust pipe of an automobile according to the present invention and FIG. 5 shows a partially enlarged view of FIG. 4, wherein a coil spring (61) is mounted on the groove (31) in place of the spring member (60).

Referring to FIGS. 2 and 3, the flexible tube of the present invention comprises a bellows member (10), and the bellows member (10) is made of metallic materials in the form of a cylinder and corrugated in its longitudinal direction to have alternate ridges (11) and furrows (12) along its outer periphery.

If the bellows member (10) is displaced axially and/or horizontally by vibrational force or external impact, the ridges (11) and the furrows (12) which have been alternately formed in the longitudinal direction along the outer periphery of the bellows member (10) are elastically bent to absorb the displacement and also the stresses due to extension, contraction and bending thereof. The bellows member (10) also prevents the leakage of exhaust gas. Then, if the external force is removed, the bellows member (10) returns to its original position.

Inside of the bellows member (10), an interlock member (20) is provided to keep a predetermined distance from the inner periphery of the bellows member (10) and is spirally wound to form spiral grooves. Both ends of the interlock member (20) are fixed in the flexible tube by respective inner sleeves (50).

Since the interlock member (20) is wound spirally and forms spiral grooves, if the external force is given to displace the interlock member (20) in the longitudinal or horizontal direction of the flexible tube, friction between parts of the spirally wound interlock member (20) causes damping effects, which absorb stresses mainly in the longitudinal direction and maintain the passage of the exhaust gas constantly, thus preventing occurrence of turbulence.

Outside of the bellows member (10), the outer braids (30) made by weaving wires at predetermined angles are provided to enclose the bellows member (10).

The wires of the outer braids (30) are a little stressed by the displacement in the direction of pressure and are elastically transformed over the tensile strength. Also, since the wires do not transform any more after being elongated by a certain length, they serve to control the displacement over the tensile strength.

Further, fixing caps (40) are respectively assembled onto both side ends of the outer braids (30), so that the wires of the outer braids (30) cannot come unweaved and both side ends of the outer braids (30) can be fixed firm around both side ends of the bellows member (10).

Along an inner surface of each end of the bellows member (10), a ring-shaped inner sleeve (50) is provided so that the interlock member (20) can be fixed with maintaining a predetermined gap from the bellows member (10).

The inner sleeve (50) comprises a fixing portion (51) and a securing portion (52) extended from the fixing portion (51) to have a diameter smaller than that of the fixing portion (51). The fixing portion (51) is fixed along the inner surface of each of the side ends of the bellows member (10), and the securing portion (52) is curved to have a smaller diameter than the fixing portion (51) and fixed on each end of the interlock member (20).

Specifically, the front end of the fixing portion (51) is positioned to be in accord with the end of the bellows member (10). The respective ends of the bellows member (10), the outer braids (30) and the fixing cap (40) are clamped together circumferentially by a clamping means. Then, they are fixed together in various spots around their circumferences by simultaneous spot welding.

The securing portion (52) of the inner sleeve (50) mounted on each end of the interlock member (20) keeps the interlock member (20) at a predetermined gap from the bellows member (10).

Meanwhile, the spring member (60) having elasticity is provided along the central circumferential surface of the outer braids (30) in such a manner to clamp the external circumference of the outer braids (30).

The groove (31) is formed along the central external circumferential surface of the outer braids (30), and the spring member (60) is seated on the groove (31) in a manner to clamp the external circumference of the outer braids (30).

Therefore, if over-vibration occurs in the exhaust system and the over-vibration is transferred to the outer braids (30), the spring member (60) absorbs the vibration by its own elastic force.

Then, if the spring member (60) absorbs the over-vibration generated in the exhaust system, it promotes the damping effect of the outer braids (30) and the bellows member (10), and thus the generation of noise and harshness can be prevented.

Further, due to the increase of the damping effect of the outer braids (30) and the bellows member (10), over-vibration of the flexible tube at its resonance frequency can also be restrained.

As shown in FIGS. 4 and 5, the coil spring (61) can be mounted on the groove (31) in place of the spring member (60) in such a manner that the coil spring (61) closely contacts with and clamps the circumferential surface of the outer braids (30).

It should be noted that any other types of springs can be used as the spring member (60) in the present invention.

As described above, according to the present invention, a flexible tube for an exhaust pipe of an automobile is provided, which includes a spring member along a circumferential surface of the outer braids to absorb the vibration from the exhaust system.

According to the present invention, the spring member cannot only absorb the over-vibration generated in the exhaust system, but also restrain the subsequent amplified over-vibration in the flexible tube.

Accordingly, in the flexible tube according to the present invention, the damping effect of the outer braids and the bellows member can significantly increase, and the generation of noise and harshness of vehicles can be prevented, so that N.H.V evaluation of the vehicles and durability of the flexible tube can be promoted.

It will be apparent to those skilled in the art that various modifications and variations can be made to the present invention without departing from the spirit and scope of the invention. The present invention covers the modifications and variations thereof provided they come within the scope of the appended claims and their equivalents.

What is claimed is:

1. A flexible tube for an exhaust pipe of an automobile comprising:
a bellows member formed in a shape of a hollow cylinder having a predetermined width and length and corrugated to have alternate ridges and furrows along its outer periphery;
outer braids woven at predetermined angles and provided at a predetermined distance from the outer periphery of the bellows member to enclose the bellows member;
fixing caps fitted onto both side ends of the outer braids respectively, so that both side ends of the outer braids can be fixed around both side ends of the bellows member; and
a spring member having elasticity and provided on a circumferential surface of the outer braids to be closely contacted thereto.

2. The flexible tube for an exhaust pipe of an automobile as claimed in claim 1, wherein a groove is formed along a central external circumference of the outer braids, and the spring member is seated on the groove in a manner to clamp the external circumference of the outer braids.

3. The flexible tube for an exhaust pipe of an automobile as claimed in claim 1, further comprising an interlock member provided in the bellows member with maintaining a predetermined distance from an inner periphery of the bellows member and spirally wound to form spiral grooves; and
ring-shaped inner sleeves, each of which comprising a fixing portion fixed along an inner surface of each side end of the bellows member and a securing portion extended and curved from the fixing portion to have a smaller diameter than the fixing portion and fixed on each side end of the interlock member.

4. The flexible tube for an exhaust pipe of an automobile as claimed in claim 2, further comprising an interlock member provided in the bellows member with maintaining a predetermined distance from an inner periphery of the bellows member and spirally wound to form spiral grooves; and
ring-shaped inner sleeves, each of which comprising a fixing portion fixed along an inner surface of each side end of the bellows member and a securing portion extended and curved from the fixing portion to have a smaller diameter than the fixing portion and fixed on each side end of the interlock member.
